(19) United States
(12) Patent Application Publication
(10) Pub. No.: US 2009/0229472 A1
(43) Pub. Date: Sep. 17, 2009

(54) BREWING SYSTEM AND PACKAGING

(76) Inventor: Daniel A. Ferrara, JR., Morris, CT (US)

Correspondence Address: MCCORMICK, PAULDING & HUBER LLP, CITY PLACE II, 185 ASYLUM STREET, HARTFORD, CT, 06103, US

(21) Appl. No.: 12/046,766

(22) Filed: Mar. 12, 2008

(51) Int. Cl. A47J 31/00

(52) U.S. Cl. 99/323

(57) ABSTRACT

A self-contained beverage brewing system for brewing a beverage includes an outer container and an inner container positionable therein. The inner container is moveable relative to the outer container between a storage/drinking position, where the inner container is positioned within an interior volume of the outer container so that respective upper rim regions of the containers are substantially adjacent to one another, and a brewing position, where the inner container is telescoped out of the interior volume of the outer container. A filter is positioned between the bottom ends of the inner container and the outer container for filtering the brewed beverage as the inner container is moved from the brewing position to the drinking position. The system can include a flexible seal connecting the respective containers, an interior collapsible bellows, a beverage module, or a combination thereof to store beverage material between the inner container and the outer container.

### FIELD OF THE INVENTION

The present invention generally relates to a beverage brewing system and packaging, and more particularly to a self-contained, disposable beverage brewing system and packaging.

### BACKGROUND OF THE INVENTION

There are a variety of methods for making a brewed beverage, such as coffee or tea, for both mass consumption and individual consumption. Traditionally, large pots of coffee can be brewed for servicing several people. A full pot of coffee, however, is often too much coffee for one individual or even a few people. Once prepared, coffee gets cold from sitting around, and drinkers prefer to have a brand new pot of hot coffee brewed, so any excess in the original pot is typically discarded. Devices have been developed for brewing single servings of coffee for individual consumption. Such devices are especially useful for the on-the-go coffee drinker. Moreover, as the types and flavors of coffee have become more varied and readily available, individuals often desire to have a single serving of a specific brewed beverage on demand, which may differ from the desired beverage of another person. Accordingly, such devices have been developed to accommodate the individual tastes of consumers and therefore supply a single serving of a beverage for the desired tastes of the individual consumer.

Coffee makers, both for mass consumption and single servings, generally are divided into devices that use either a drip/pressure method or an infusion method. Drip coffee makers usually have internal heating elements that heat water applied to coffee grounds. Heating elements may be positioned above a carafe to heat the water as it mixes with the coffee grounds, such that after the heated water is mixed with the coffee grounds, the brewed coffee will drip into the carafe. Alternatively, heating elements may be positioned below the carafe to heat the mixed water and coffee grounds after the mixture drips into the carafe. Once brewed, the coffee can be poured into a cup for consumption.

Infusion coffee makers, by comparison, usually use an external heating element. That is, the water typically is pre-heated before it is added to the coffee maker. A popular manual coffee maker is the press pot, or the French press coffee maker, which comprises a carafe and a plunging device with a filter attached. The filter is usually a mesh screen mounted on a disk that is attached to a metal rod extending out of the carafe. Coffee grounds are placed in the carafe in the desired amount. Hot water is added to the carafe and the plunging device is mounted on and in the carafe. The rod is plunged up and down several times to agitate the coffee grounds. When the coffee has been sufficiently brewed, the plunging device is placed at its lowest position within the carafe to trap the coffee grounds beneath the filter so that the brewed coffee can be poured into a separate coffee cup for drinking. Press pot coffee makers are desirable for making single cup servings of coffee, but can also be used to make batches of 4 to 8 cups of coffee. Similar infusion-style devices are also used for making tea.

Based on consumer testing and professional coffee grading practices, the infusion method has been considered to be the best method for making coffee. However, with existing press pot designs, the coffee is brewed in the press pot and then poured into a separate coffee cup for drinking with the coffee grounds sifted out by the press pot filter. After use, the used grounds must be disposed of and the used pot must be cleaned before reuse. Additionally, such devices are more suited to home use, and do not lend themselves well for travel or for purchase or use in convenience store or restaurant settings.

In view of the foregoing, there is a need for a beverage brewing system and packaging that permits quick and easy brewing for individual consumption that provides a self-contained brewing method, including a pre-packaged beverage material in a desirable amount, so that one does not need both a brewing device and a separate drinking cup. Additionally, there is a need for such a beverage brewing system and packaging that is disposable after use, such that the used grounds are disposed with the system.

### SUMMARY OF THE INVENTION

In one aspect of the present invention, a beverage brewing system for making a brewed beverage, comprises a first outer container and a second inner container positionable therein. The first outer container has a top end defining an opening and an upper rim region, a closed bottom end, and a generally upstanding sidewall connecting the upper rim region and the closed bottom end, said sidewall extending around the perimeter of said first outer container and defining an interior volume of said first outer container. The second inner container has a top end defining an opening and an upper rim region, a bottom end defining an opening and a lower rim region, and a generally upstanding sidewall connecting the upper rim region and the lower rim region, said sidewall extending around the perimeter of said second inner container and defining an interior volume of said second inner container. A filter is positioned between the open bottom end of the second inner container and the closed bottom end of the first outer container. A beverage material is disposed between the filter and the closed bottom end of the second outer container. The second inner container is movable with respect to the first outer container between a drinking position where the second inner container is positionable in the interior volume of the first outer container such that the respective upper rim regions of the first inner container and the second outer container are generally adjacent to one another, and a brewing position where the second inner container is telescoped out of the interior volume of the first outer container. The filter similarly moves with the second inner container so that when the second inner container is positioned in the brewing position a liquid can pass through the second inner container and the filter and into the interior volume of the first outer container for brewing of the beverage material housed therein.

In another aspect of the present invention, the beverage brewing system may include a flexible seal connecting the respective upper rim regions of the first outer container and the second inner container. The flexible seal is preferably extended, unfolded or stretched when the second inner container is telescoped out of the interior volume of the first outer container, and thus positioned in the brewing position. The flexible seal is also preferably collapsed, compressed, folded or relaxed when the second inner container is positioned in the drinking position within the interior volume of the first outer container. The seal helps in maintaining the positioning of the second inner container as it is moved, as well as providing a closure to the space between the inside wall of the first outer container and the outside wall of the second inner container to keep loose beverage material in the space between the two containers and prevent displacement of water when the second inner container is pressed into the first outer container after water has been added to the beverage brewing system.

In another aspect of the present invention, the beverage brewing system may include a flexible seal in the form of a collapsible sleeve disposed within the interior volume of the first outer container and connecting the bottom end or exterior surface of the second inner container to the first outer container. The collapsible sleeve defines an interior volume for storing the beverage material, typically in combination with a portion of the outer surface of the second inner container and a portion of the inner surface of the first outer container. The sleeve is collapsible such that when the second inner container is positioned with respect to the first outer container at a drinking position the sleeve is compressed, and when the second inner container is positioned with respect to the first outer container at a brewing position the sleeve is extended.

In another aspect of the present invention, the collapsible sleeve of the beverage brewing system may take the form of a collapsible bellows disposed within the interior volume and movable between a compressed position and an extended position in conjunction with movement of the second inner container relative to the first outer container.

In another aspect of the present invention, the beverage brewing system may include a beverage module for storing the beverage material to be brewed. The beverage module is supported by a support structure and includes a lower seal, a filter positioned atop the beverage module, and a cover seal disposed atop said filter. The support structure, the filter and the beverage module are moveable with the second inner container so that when the second inner container is positioned in the brewing position a liquid can pass through the second inner container, the support structure, the filter and the beverage module and into the interior volume of the first outer container for brewing of the beverage material housed in the beverage module after the cover seal and the lower seal have been breached to expose the beverage material.

In another aspect of the present invention, the beverage brewing system may include a beverage module attached to the interior bottom end of the first outer container. The beverage module includes a cover seal for maintaining the beverage material within the beverage module when the beverage brewing system is not in use, wherein removal of the cover seal from the module exposes the beverage material to facilitate brewing of a beverage. Movement of the second inner container relative to the first outer container may effect removal of the cover seal.

The present invention provides a beverage brewing system that permits quick and easy brewing of a beverage without the need for both a brewing device and a separate drinking container. The design of the system provides a self-contained brewing device, including a pre-packaged beverage material in a desirable amount. Additional advantages include easy stackability of numerous devices for sale to the public, adaptability to distinct beverage tastes by varying the pre-packaged beverage material contained within the brewing system, adaptability to varying beverage sizes, and capacity of easy disposability after use, including disposal of used beverage material.

These and other features of the present invention are described with reference to the drawings of preferred embodiments of a beverage brewing system and packaging. The illustrated embodiments of the beverage brewing systems of the present invention are intended to illustrate, but not limit the invention.

### BRIEF DESCRIPTION OF THE DRAWINGS

FIG. 1 is a perspective view of a beverage brewing system in accordance with an embodiment of the present invention with an inner cup positioned within an outer cup at a storage/drinking position.

FIG. 2 is a perspective view of the beverage brewing system of FIG. 1 with the inner cup telescoped out of the outer cup to a brewing position.

FIG. 3 is a cross-sectional side view of the beverage brewing system of FIG. 1 with the inner cup in the storage/drinking position and using a flexible seal to connect respective upper rim regions of the inner cup and the outer cup.

FIG. 4 is a cross-sectional side view of the beverage brewing system of FIG. 3 with the inner cup in the brewing position.

FIG. 5 is a partial cross-sectional side view of the beverage brewing system of FIG. 3 illustrating use of a shroud on the inner cup.

FIG. 6 is a cross-sectional side view of an alternate embodiment of a beverage brewing system in accordance with the present invention with an inner cup positioned within an outer cup at a storage position and using an inner flexible sleeve to contain beverage material.

FIG. 7 is a cross-sectional side view of the beverage brewing system of FIG. 6 with the inner cup in the brewing position.

FIG. 8 is a cross-sectional side view of an alternate embodiment of a beverage brewing system in accordance with the present invention with an inner cup positioned within an outer cup at a storage position and using a beverage module to contain beverage material.

FIG. 9 is a cross-sectional side view of the beverage brewing system of FIG. 8 with the inner cup positioned at a preferred drinking position within the outer cup.

FIG. 10 is a cross-sectional side view of the beverage brewing system of FIG. 8 with the inner cup telescoped out of the outer cup to a brewing position.

FIG. 11 is an exploded view of the beverage brewing system of FIG. 8.

FIG. 12A is a close-up cross-sectional side view of a beverage module and support structure assembly for use in the beverage brewing system of FIG. 8.

FIG. 12B is a close-up cross-sectional side view of a collapsed beverage module and support structure assembly in accordance with an intended use the beverage brewing system of FIG. 8.

FIG. 13 is a cross-sectional side view of an alternate embodiment of a beverage brewing system in accordance with the present invention, with an inner cup positioned within an outer cup at a storage position, and using a beverage module to contain beverage material.

FIG. 14 is a cross-sectional side view of the beverage brewing system of FIG. 13 with the inner cup telescoped out of the outer cup to a brewing position.

FIG. 15A is a cross-sectional top view of the beverage module of FIG. 13 taken along line 15A-15A of FIG. 13.

FIG. 15B is a cross-sectional top view of the beverage module of FIG. 13 taken along line 15B-15B of FIG. 14.

FIG. 16 is a cross-sectional side view of an alternate embodiment of a beverage brewing system in accordance with the present invention with an inner cup positioned within an outer cup at a storage and drinking position and using bellows to contain beverage material.

FIG. 17 is a cross-sectional side view of the beverage brewing system of FIG. 17 with the inner cup telescoped out of the outer cup to a brewing position.

FIG. 18 is a cross-sectional side view of an alternate embodiment of a beverage brewing system in accordance with the present invention with an inner cup positioned within an outer cup at a storage and drinking position and using bellows to contain beverage material.

FIG. 19 is a cross-sectional side view of the beverage brewing system of FIG. 19 with the inner cup telescoped out of the outer cup to a brewing position.

### DETAILED DESCRIPTION OF THE INVENTION

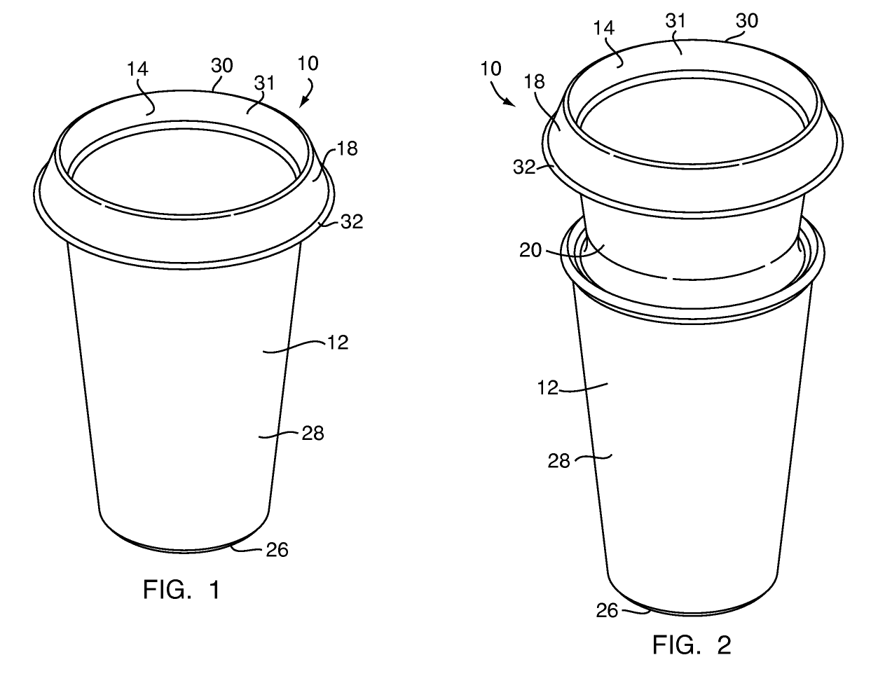

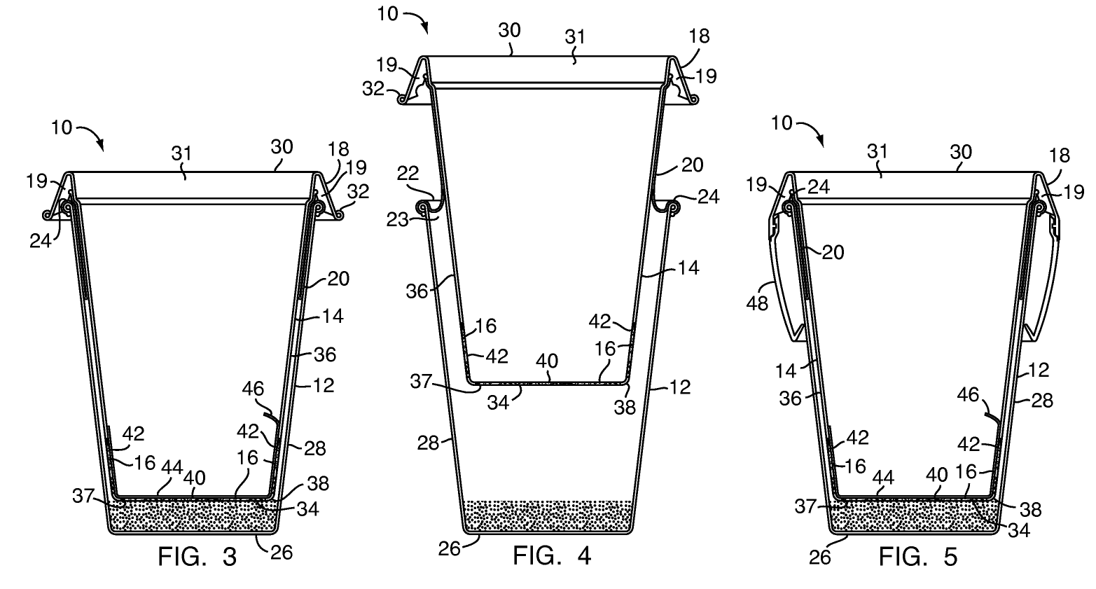

Referring to FIGS. 1-2, a beverage brewing system in accordance with a preferred embodiment of the present invention is generally shown as reference numeral 10. The system 10 generally comprises two containers (such as first outer cup 12 and second inner cup 14) that telescope relative to one another to brew a beverage using the infusion method. The first outer cup 12 and the second inner cup 14 each preferably have substantially identical size and configuration. In use, the inner cup 14, is positioned within the outer cup 12. As shown in more detail in FIGS. 3-4, the system 10 further comprises a filter layer 16 positioned between the outer cup 12 and the inner cup 14, a lip 18 on the inner cup 14 to facilitate drinking of a brewed beverage, and a resilient retention surface 19 provided on the inner surface of the lip 18 for holding the second inner cup 14 and the first out cup 12 together, as shown in FIG. 3 and described in more detail below.

The system 10 may also comprise many additional features for containing a beverage material within the system 10 and for facilitating brewing of a beverage using such material, as will be described herein with reference to the Figures. For example, FIGS. 3-4 illustrate a flexible seal 20 connecting the outer cup 12 and the inner cup 14 for maintaining the positioning of the inner cup 14 as it is moved relative to the outer cup 12, as well as keeping loose beverage material in the space between the two cups and preventing displacement of water, or other liquid, when the beverage is brewed through the infusion method.

The outer cup 12 includes a top end 22 defining an opening 23 and an upper rim region 24, a closed bottom end 26, and a generally upstanding sidewall 28 connecting the upper rim region 24 and the bottom end 26. The perimeters defined by the top end 22 and the bottom end 26 may have the same size or different sizes. In accordance with common disposable cup designs, the top end 22 and the bottom end 26 have generally circular perimeter shapes and the sidewall 28 extends circumferentially around the cup connecting the respective circular perimeters defined by the top end 22 and the bottom end 26. Where the top end 22 has a larger circumference than the bottom end 26, the sidewall 28 defines a generally frustoconical shape, as generally illustrated in FIGS. 1-2. Where the top end 22 and the bottom end 26 have identical circumferences, the sidewall 28 defines a generally cylindrical shape.

The inner cup 14 preferably has substantially similar size and configuration as the outer cup 12 and is designed to fit therein, as shown in FIG. 1. Accordingly, the inner cup 14 comprises a top end 30 defining an opening 31 and an upper rim region 32, a bottom end 34 (see, e.g., FIG. 3), and a generally upstanding sidewall 36 connecting the upper rim region 32 and the bottom end 34 and extending circumferentially around the cup. When the inner cup 14 is positioned within the outer cup 12, the outer surface of the sidewall 36 of the inner cup 14 is generally complementary to the inner surface of the sidewall 28 of the outer cup 12, and the respective upper rim regions 24 and 32 are generally adjacent to one another. The lip 18, as illustrated, is formed at the upper rim region 32, extending downwardly towards the bottom end of the cups. As designed, the lip 18 envelops the upper rim region 24 of the outer cup 12 when the inner cup 14 is positioned therein, and thus facilitates drinking of a brewed beverage when the cups are pressed together. More specifically, the resilient retention surface 19 on the lip 18 is press-fit around the upper rim region 24 of the outer cup 12 to hold the cups together. In order to dislodge the inner cup 14 so as to move it to the position shown in FIG. 4, upward force on the lip 18 should be sufficient to disengage the resilient retention surface 19 from the upper rim region 24.

Referring to FIG. 1, the inner cup 14 is shown inside the interior volume of the outer cup 12 in a storage position (i.e., the preferred respective positions of the cups prior to use of the beverage brewing system 10), and ultimately a drinking position (i.e., the preferred respective positions of the cups during drinking, after the beverage has been brewed). Referring to FIG. 2, the inner cup 14 is shown telescoped out of the interior volume of the outer cup 12 through the opening 23. The inner cup 14 is thus in a preferred brewing position whereby the desired beverage can be brewed for consumption. In use of the beverage brewing system 10 of the present invention, the cups are preferably stored in the storage position where unused beverage material is stored between the cups. When a user wants to brew a beverage, the user moves the inner cup 14 to the brewing position and adds hot liquid, such as water, through the opening 31 of the inner cup 14. After the beverage has been brewed, the user returns the inner cup 14 to the drinking position so that the respective upper rim regions 24 and 32 are generally adjacent one another and preferably the resilient retention surface 19 fits around the upper rim region 24 of the outer cup 12 to hold the two cups in the drinking position. Though the brewing process is described herein with respect to water, the present invention can be used with any liquid capable of brewing a beverage material, preferably a hot liquid.

Whereas the outer cup 12 has a closed bottom end 26, the inner cup 14 preferably has a bottom end 34 defining an opening 37 and a lower rim region 38 to facilitate brewing of beverage materials contained within the beverage brewing system 10. That is, to brew a beverage, the inner cup 14 is raised to the telescoped brewing position illustrated in FIG. 2 so that water, at a desired brewing temperature, can be poured into the inner cup 14 and through its open bottom end 34 into a brewing volume defined mostly by the interior volume of the outer cup 12 where it can mix with beverage material, such as coffee grounds, tealeaves or the like, stored therein. The inner cup 14 is preferably maintained in the telescoped brewing position for a desired period of time to allow the beverage to properly brew (typically between about thirty seconds and one minute if the water is at an appropriate temperature). To drink the beverage, the inner cup 14 is lowered back into the outer cup 12 to the drinking position, avoiding unwanted displacement of the liquid contained therein.

To prevent loose beverage material from passing into the interior volume of the inner cup 14 when it is retracted to the drinking position, the filter layer 16 is provided between the beverage material and the interior volume of the inner cup 14. The filter layer 16 also filters the brewed beverage from the loose beverage material, in accordance with traditional infusion-style brewing techniques, as the inner cup 14 is moved relative to the outer cup 12 to the drinking position. As shown in more detail in FIGS. 3 and 4, the filter layer 16 comprises a lower filter portion 40 mounted on the lower rim region 38 of the inner cup 14 and side filter portions 42 disposed in the sidewall 36 of the inner cup 14. As also shown, a seal layer 44 covers the filter portions 40 and 42 to prevent water or foreign materials from prematurely mixing with beverage material stored within the beverage brewing system 10, especially during storage. When the beverage brewing system 10 is to be used, the seal layer 44 is removed to expose the brewing material. However, the brewing material is still maintained behind the filter layer 16 so that loose brewing material cannot pass into the interior volume of the inner cup 14. When water is poured into the inner cup 14, it will pass through the lower filter portion 40 and the side filter portions 42 and interact with the brewing material so that the beverage can be brewed.

As shown, the beverage material is loosely contained within the interior volume of the outer cup 12. The filter layer 16 and the seal layer 44 protect loose beverage material from being contaminated or from spilling out of the beverage brewing system 10, especially if stored upside down, such as in a stack of cups. It is desirable to keep the beverage material fresh when it is stored so that when it is used, the beverage will have maximum taste and flavor. It is envisioned that the beverage brewing system 10 of the present invention be used in stores, restaurants and cafeterias where the cups will be stacked for individual use and may be stored for undetermined periods of time. Accordingly, the beverage material is pre-packed to withstand unknown periods of storage. The entire beverage brewing system 10 is preferably sealed using a nitrogen gas sealing method after the beverage material has been added. For example, coffee can be packaged in a nitrogen atmosphere to keep it fresh over a long period of time. The seal layer 44 is preferably made from materials, such as shrink film or aluminum coated with polyethylene, that are impervious to aroma and oils from the packed beverage to keep the beverage material fresh while being stored. Similarly, the flexible seal 20 connected the upper portions of the outer cup 12 and the inner cup 14 is made from an elastomeric material that preserves the vacuum seal of the system 10 until it is used to brew a beverage. In order to use the system 10, the user removes the seal layer 44, preferably by reaching into the inner cup 14 and pulling a tab 46 provided on the seal layer 44 to facilitate its removal. Alternatively, the seal layer 44 can envelope the entire system 10 to seal both containers and the beverage material inside to make the system 10 a total sealed and contained unit.

Alternatively, the beverage material can be stored within a beverage module, which is also made from materials that are impervious to aroma and oils, stored between the respective bottom ends 26 and 34 of the outer and inner cups 12 and 14. The seal layer 44 can be provided on the upper end of the module, beneath the filter layer 16, and attached to the inner cup 14 so that when the inner cup 14 is moved with respect to the outer cup 12 (e.g., telescoped or twisted), the seal layer 44 is removed from the beverage module to expose the beverage material and allow it to be dispersed within the brewing volume. Still alternatively, the seal layer 44 could be made from a material that will dissolve or degrade in hot water so as to combine the step of exposing the beverage material with the act of adding hot water to the beverage brewing system 10.

Examples of suitable filter material include polyethylene, nylon or other synthetic mesh or screen, permeable cloth materials, or paper materials with openings or perforations, provided any such openings are sufficiently small so that coffee grounds, tea leaves or the like do not pass through. The filter material used in the present invention is preferably a porous polyethylene material, such as SAATIFIL® polyester, with a mesh opening of sufficient size—e.g., on the order of about 4 to 7 microns—to allow passage of water without undesirable build-up while also preventing loose beverage materials from leaking into the beverage when the user is drinking it.

Though the preferred embodiment of the inner cup 14 is to have a lower filter portion 40 and side filter portions 42 mounted to the inner cup 14, alternate embodiments may utilize an inner cup 14 having a porous bottom end that incorporates or acts as a filter layer through which the water can pass but which also prevents beverage material from passing into the interior of the inner cup 14 once it is retracted to the drinking position. Further, though filters are used on both the bottom end 34 of the inner cup 14 and on the sidewall 36, the beverage brewing system 10 can be designed with a filter layer on just the bottom end 34 or just the sidewall 36.

In a preferred design of the beverage brewing system 10 illustrated in FIGS. 3-4, a flexible seal 20 is mounted to the respective upper rim regions 24 and 32 of the outer cup 12 and the inner cup 14 to limit movement of the inner cup 14, to prevent the inner cup 14 from being completely removed from the outer cup 12, to provide stability to the inner cup 14 as it is moved between the storage/drinking position and the brewing position, and to prevent spilling or displacement of loose beverage material or water, especially when the inner cup 14 is moved back into the outer cup 12 after a beverage has been brewed. Preferably, the flexible seal 20 is in the form of a sleeve that provides a closure to the space between the inside wall of the outer cup 12 and the outside wall of the inner cup 14. As illustrated in FIG. 5, a shroud 48 can be mounted on the lip 18 to provide added protection for the flexible seal 20, as well as to hide the seal from view.

The seal 20 is extended when the inner cup 14 is telescoped out of the interior volume of the outer cup 12 and collapsed when the inner cup 14 is at the drinking position within the interior volume of the outer cup 12. Depending on the material and design of the seal 20, the seal 20 may be extended and collapsed in various manners. For example, the seal 20 may be made from an elastomeric material that allows it to stretch as the inner cup 14 is telescoped to a brewing position and to relax to a compressed state when the inner cup 14 is returned to the drinking position. In this sense, the seal 20 biases the inner cup 14 towards the drinking position.

Alternatively, the seal 20 can be a loose sleeve that folds and unfolds between collapsed and extended states with the respective movement of the inner cup 14. In a preferred embodiment, the seal 20 forms a compression sleeve around the sidewall 36 of the inner cup 14 as it is telescoped out from the outer cup 12. That is, the seal 20 tightly fits around the circumference of the inner cup 14, and as the inner cup 14 extends away from the outer cup 12, the seal material lies essentially flush against the sidewall 36. At the lower end of the seal 20, the material extends essentially radially outwardly towards the upper rim region 24 of the outer cup 12 where it is attached. If no pressure is applied to the inner cup 14 when telescoped to the brewing position, the seal material lies essentially parallel to the planar surface of the cups, as seen in FIG. 4, and the inner cup 14 can be held in place by the resiliency of the seal material. As the inner cup 14 is pressed into the outer cup 12, the seal remains snug against the sidewall 36 and slides into the space between the respective sidewalls 28 and 36 until there is an upward tugging force from the connection point between the seal 20 and the upper rim region 24 of the outer cup 12. When the tugging force is applied, the seal 20 starts to peel away from sidewall 36. In the drinking position of the cups, the seal is in its collapsed state, as shown in FIG. 3. In this state, the seal material may be folded upon itself.

When using the flexible seal 20 with the beverage brewing system 10 of the present invention, air may be entrapped in the space between the outer cup 12 and the inner cup 14, especially where the seal 20 is made from a material with lower air permeability. For example, the telescoping movement of the inner cup 14 with respect to the outer cup 12 to the brewing position, coupled with the flexing of the seal 20 between a relaxed position and an extended position, can trap an air bubble in the interior volume of the outer cup 12. The air bubble may affect the ability of the user to press the inner cup 14 back into the outer cup 12 after the beverage has been brewed. Accordingly, the side filter portions 42 disposed in the sidewall 36 of the inner cup aid in alleviating the affect of such an air bubble.

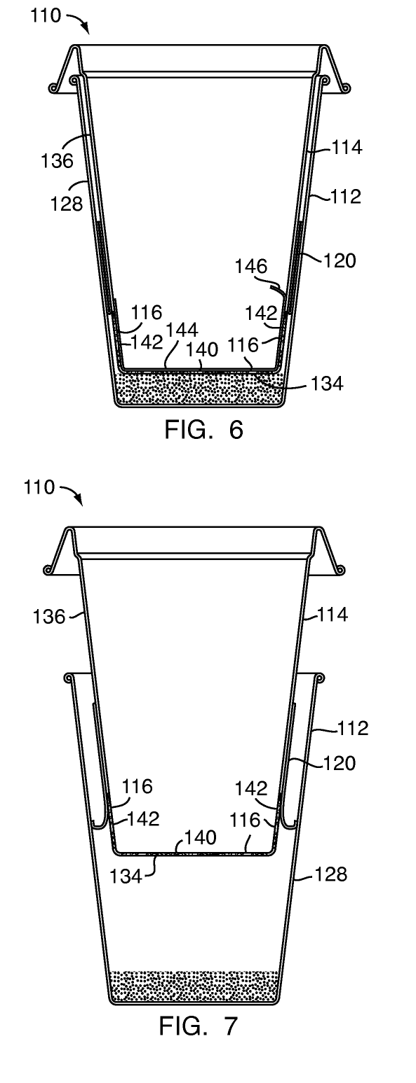

Referring to FIGS. 6-7, an alternate beverage brewing system in accordance with the present invention is generally shown as reference numeral 110. The system 110 generally comprises a first outer cup 112 and a second inner cup 114 that each preferably have substantially identical size and configuration, much in the same manner as the beverage brewing system 10 described above. In use, the inner cup 114 is positioned within the outer cup 112. For convenience, similar components in the cups 112 and 114 utilize similar reference numerals as used with respect to beverage brewing system 10, described above. The system 110 further comprises a filter layer 116, and an interiorly disposed flexible sleeve 120 for facilitating brewing of a beverage in the system 110, as will be described in more detail below.

Referring to FIG. 6, the inner cup 114 is shown inside the interior volume of the outer cup 112 in a storage position and ultimately a drinking position. Referring to FIG. 7, the inner cup 114 is shown telescoped out of the interior volume of the outer cup 112, and is thus in a preferred brewing position whereby the desired beverage can be brewed for consumption. In use of the beverage brewing system 110, the cups are preferably stored in the storage position where unused beverage material is contained within a space defined between the cups by the sleeve 120. When a used wants to brew a beverage, the user raises the inner cup 114 to the telescoped brewing position so that water, as a desired brewing temperature, can be poured into the inner cup 114 and through the filter layer 116 into a brewing volume defined mostly by the sleeve, where the water can mix with beverage material.

To prevent loose beverage material from passing into the interior volume of the inner cup 114 when it is retracted to the drinking position, the filter layer 116 is provided between the beverage material and the interior volume of the inner cup 114, preferably at a bottom end 134 of the inner cup 114. As shown in more detail in FIGS. 6 and 7, the filter layer 116 comprises a lower filter portion 140 and side filter portions 142. A seal layer 144 with a removal tab 146 is provided over the lower filter portion 140 and the side filter portions 142 to prevent water or foreign materials from prematurely mixing with beverage material stored within the interior volume defined, in part, by the sleeve 120, especially during storage of the beverage brewing system 110. When the beverage brewing system 110 is to be used, the seal layer 144 is removed to expose the brewing material. However, the brewing material is still maintained behind the filter layer 116 so that loose brewing material cannot pass into the interior volume of the inner cup 114. When water is poured into the inner cup 114, it will pass through the filter layer 116 and interact with the brewing material so that the beverage can be brewed.

The sleeve 120 is mounted to the outer surface of the inner cup 114 and the inner surface of the outer cup 112, so as to define an interior space between the cups that is sealed, by the sleeve 120. As shown in FIGS. 6-7, one end of the sleeve 120 is attached to the inner surface of the outer cup 112 about mid-way up the sidewall. The other end of the sleeve 120 is attached to the outer surface of the inner cup 114 about mid-way up the sidewall, preferably at a position above the side filter portions 142. Alternatively, the sleeve 120 may be attached between the respective bottom ends of the outer and inner cups 112 and 114, much in the manner illustrated in FIGS. 16-19 of the present invention. The attachments are preferably by means of ultrasonic weld or heat and water resistant adhesive, such as hot glue. The sleeve 120 is preferably constructed from a flexible, heat-proof polymeric material so that it can be collapsed and stretched with the telescoping movement of the inner cup 114 with respect to the outer cup 112 without undue wear. Thus, with reference to FIG. 6, when the inner cup 114 is in the storage/drinking position, the sleeve 120 is collapsed in the annular space between the inner cup 114 and the outer cup 112. During storage, the seal layer 144 is positioned over the filter layer 116 and the beverage material is maintained within the interior space between the cups and topped off by the sleeve 120.

With reference to FIG. 7, when the inner cup 114 is telescoped to the brewing position, the sleeve 120 is stretched to define a brewing volume sealed off by the sleeve 120 in which the beverage material is free to mix with water once the seal layer 144 is removed and the water is poured into the inner cup 114 and through the filter layer 116. After the beverage has been brewed, the inner cup 114 is returned to the drinking position within the outer cup 112, where brewed beverage will seep through the filter layer 116 and into the interior volume of the inner cup 114, the loose beverage material will be restrained by the filter layer 116 and the sleeve 120 will collapse between the inner cup 114 and the outer cup 112. As the inner cup 114 is moved into the outer cup 112, the sleeve 120 also acts to prevent displacement of beverage between respective sidewalls 128 and 136 of the outer and inner cups 112 and 114.

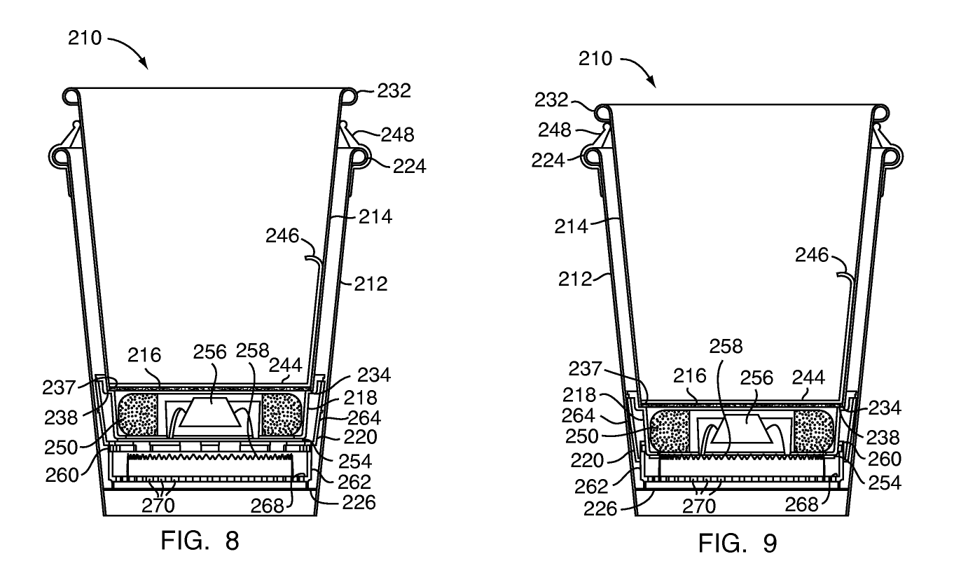

Referring to FIGS. 8-11, a beverage brewing system in accordance with a preferred embodiment of the present invention is generally shown as reference numeral 210. The system 210 generally comprises a first outer cup 212 and a second inner cup 214 that each preferably have substantially identical size and configuration, much in the same manner as the beverage brewing systems 10 and 110 described above. In use, the inner cup 214 is positioned within the outer cup 212. For convenience, similar components in the cups 212 and 214 utilize similar reference numerals as used with respect to beverage brewing system 10, described above. The system 210 further comprises a filter 216, a beverage module 218, and a support structure 220 for holding the beverage module 218 in a desired position between the outer cup 212 and the inner cup 214, as will be described in more detail below.

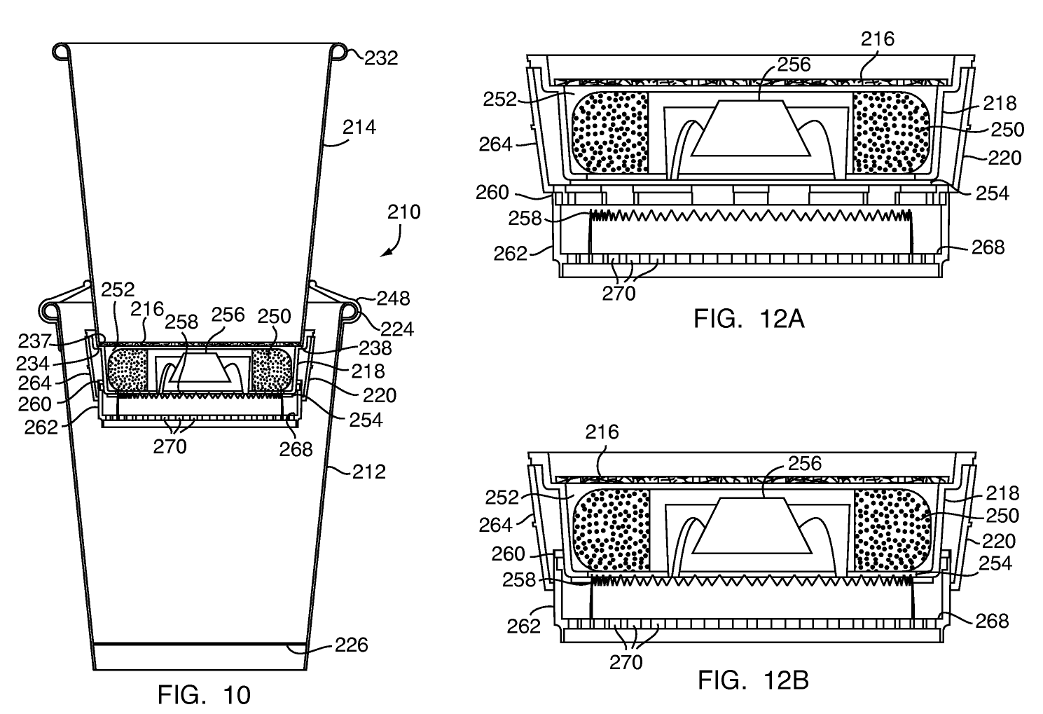

Referring to FIG. 8, the inner cup 214 is shown inside the interior volume of the outer cup 212 in a storage position (i.e., the preferred respective positions of the cups prior to use of the beverage brewing system 210). Referring to FIG. 9, the inner cup 214 is shown in a desirable drinking position (i.e., the preferred respective positions of the cups after a beverage has been brewed). Due to the design of the components inside the system 210, as discussed in more detail below, the cups 212 and 214 are compressed together to such a drinking position, albeit slightly, to facilitate the brewing process. Thereafter, the inner cup can be moved to a preferred brewing position whereby the desired beverage can be brewed for consumption. Referring to FIG. 10, the inner cup 214 is shown telescoped out of the interior volume of the outer cup 212. Referring again to FIG. 9, the inner cup 214 is returned to the drinking position after brewing, namely, to a position within the outer cup 212.

In use of the beverage brewing system 210 of the present invention, the cups are preferably stored in the storage position where unused beverage material is maintained with the beverage module 218. Generally, when a user wants to brew a beverage, the user moves the inner cup 214 to the brewing position and adds water. After the beverage has been brewed, the user moves the inner cup 214 to the drinking position. A flexible, annular gasket 248 is mounted on an upper rim region 224 of the outer cup 212 to limit movement and maintain the position of the inner cup 214, to prevent the inner cup 214 from being completely removed from the outer cup 212, and to provide stability to the inner cup 214 as it is moved between the storage/drinking position and the brewing position, as well as to prevent spilling or displacement of beverage material or water. Alternatively, the flexible seal 20 shown in FIGS. 3 and 4 or sleeve 120 shown in FIGS. 6 and 7 may be used on the beverage brewing system 210.

The inner cup 214 preferably has a bottom end 234 defining an opening 237 and a lower rim region 238 to facilitate brewing of beverage materials contained within the beverage module 218. That is, to brew a beverage, the inner cup 214 is raised to the telescoped brewing position illustrated in FIG. 10 so that water, at desired brewing temperature, can be poured into the inner cup 214 and through the opening 237 in its bottom end 234, and the filter layer 216 into a brewing volume defined mostly by the outer cup 212 where it can mix with beverage material from the beverage module 218. The beverage material contained in the beverage module 218, such as coffee grounds, tea leaves or the like, is distributed into the brewing volume in one of many ways discussed below. The inner cup 214 is preferably maintained in the telescoped brewing position for a desired period of time to allow the beverage to properly brew (typically between about thirty seconds and one minute if the water is at an appropriate temperature). To drink the beverage, the inner cup is lowered back into the outer cup 212 to the drinking position, avoiding unwanted displacement of the liquid contained therein.

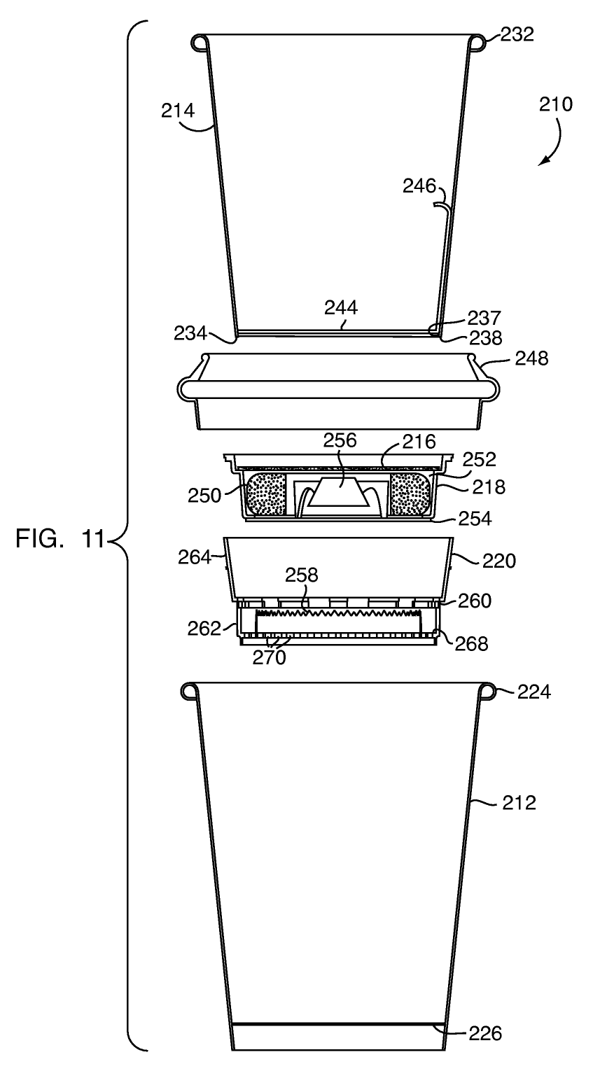

The filter layer 216 is provided between the beverage material and the interior volume of the inner cup 214 to prevent loose beverage material from passing into the interior volume of the inner cup 214 when it is retracted to the drinking position. As shown in more detail in FIG. 11, the beverage material, generally designated by reference numeral 250, is maintained within an interior cavity 252 of the beverage module 218. The beverage module 218 comprises an upper seal 244 to contain the beverage material 250 within the module 218 when the beverage brewing system 210 is not in use. The filter layer 216 is preferably disposed in the upper end of the module 218 beneath the upper seal 244. When the beverage brewing system 210 is to be used, the upper seal 244 is removed to expose the beverage material 250. However, the beverage material 250 is still maintained behind the filter so that loose beverage material 250 cannot pass into the interior volume of the inner cup 214. When water is poured into the inner cup 214, it will pass through the filter layer 216 and interact with the beverage material 250 so that the beverage can be brewed.

As shown in FIG. 8, the beverage module 218 is mounted at the bottom end of the inner cup 214. The upper seal 244 preferably has a tab 246 for removing the seal 244 so that the beverage material 250 can be exposed and brewed when water is introduced to the brewing system 210. That is, when the user wants to brew a beverage, the user can reach into the interior volume of the inner cup 214 and pull the tab 246 to remove the upper seal 244. The beverage material 250 is accordingly exposed but maintained behind the filter layer 216.

In making a beverage using the infusion method, it is desirable to increase the volume in which the beverage material 250 is contained for interaction and mixing with water, and thus improving the brewing of the beverage. In the brewing system 210 of the present invention, the interior volume of the outer cup 212 effectively acts as the brewing volume for the beverage when the inner cup 214 is telescoped out to the brewing position. It is similarly desirable to spread the beverage material 250 throughout the brewing volume once mixed with hot water to improve the flavor and strength of the brewed beverage. However, the beverage material 250 is tightly packed in the beverage module 218 for storage. Accordingly, the beverage module 218 must be manipulated to facilitate the spreading of the beverage material 250 into and throughout the brewing volume.

As shown in FIG. 12A, the beverage module 218 is mounted within the support structure 220 which may also be mounted at the bottom end 234 of the inner cup 214 so that the beverage module 218 and the support structure 220 move with the inner cup 214 (as illustrated in FIGS. 8 and 10). The beverage module 218 includes a lower seal 254 that maintains the beverage material 250 inside the beverage module 218 when the brewing system 210 is not in use, and accordingly prevents dry beverage material 250 from spilling should the beverage module 218 be accidentally removed from the brewing system 210 before use. Prior to adding water to the brewing system 210 as described above, the lower seal 254 is breached so that the loose beverage material 250 can spread throughout the brewing volume. Once water is added, further spreading of the beverage material 250 is achieved as the water passes through the inner cup 214 and the filter layer 216 and into the beverage module 218. The water will then interact with the beverage material contained within the beverage module 218 and pass out of the breached lower end thereof. The combination water and beverage material will then fill the brewing volume defined by the interior volume of the outer cup 212 where the beverage will be brewed. The beverage module 218 can further include a water flow diverting means, such as frustoconical member 256 illustrated in FIG. 11, to further assist in spreading the beverage material 250 by diverting the path of the water as it passes through the beverage module 218 and indeed causing the water to agitate or swirl to mix the water with the beverage material as the flow of the water is redirected within the brewing space.

As illustrated more closely in FIGS. 12A-12B, the lower seal is breached by the support structure 220. Preferably, the support structure 220 includes a plurality of projections or teeth 258 that perforate the lower seal 254. As noted, the support structure 220 is mounted at the bottom end 234 of the inner cup 214 with the beverage module 218 maintained between the support structure 220 and the inner cup 214. When the beverage brewing system 210 is being stored, prior to use, the lower end of the support structure 220 abuts the inner surface of the closed bottom end 226 of the outer cup 212, as shown in FIG. 8. Accordingly, the inner cup 214 is slightly displaced out of the outer cup 212. When the user wants to brew a beverage using the brewing system 210, the user presses down on the inner cup, with upward resistance on the outer cup, so that the respective bottom ends 226 and 234 of the cups, and similarly, the respective upper rim regions 224 and 232, move towards one another. Due to this compressive action, frangible flanges 260 on the support structure 120 fracture so that it collapses, as shown in FIGS. 9 and 12B. As the support structure 120 collapses, with a lower portion 262 of the support structure 220 moving into an upper portion 264 of the support structure 220, the teeth 258 in the support structure 220 perforate the lower seal 254 on the beverage module 218. The teeth 258 are prevented from breaching the filter layer 216 due to the movement of the lower portion 262 of the support structure 220 being restricted by the upper portion 264 of the support structure 220 and/or the structure of the beverage module 218 housed in the upper portion 264. After the lower seal 254 has been breached, the user can remove the upper seal 244 from the beverage module 218, raise the inner cup 214 out of the outer cup 212 to the telescoped brewing position, add the desired amount of water, and wait the desired time for the beverage to brew. After the beverage has been sufficiently brewed, the user can push the inner cup 214 down within the outer cup 212 as far as it can go to the drinking position. The filter layer 216 will allow the brewed beverage to pass through into the interior volume of the inner cup 214 while keeping the used beverage material—i.e., coffee grounds, tea leaves or the like—in the space between the filter layer 216 and the outer cup 212. The user can then drink the beverage.

The support structure 220 preferably has centrally located openings so that water and beverage material can pass through into the brew volume of the outer cup 212. In the illustrated embodiment, the teeth 258 are arranged in a circle and are supported by an annular ring 268 that is provided with a plurality of openings 270 so that water and beverage material can pass through the ring and do not build up on the support structure 220. Alternate designs of the support structure and the projections for breaching the lower seal 254 of the beverage module 218 may be used, provided the lower seal is adequately breached to facilitate spreading of beverage material and water into and throughout the brewing volume.

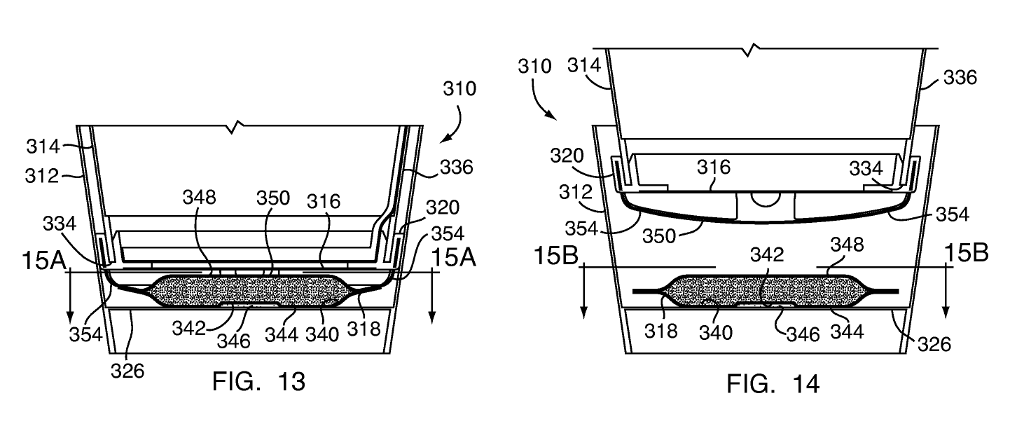

An alternative beverage brewing system 310 in accordance with the present invention is illustrated in FIGS. 13-14. The system 310 generally comprises a first outer cup 312 and a second inner cup 314, each preferably having substantially identical size and configuration, much in the same manner as the beverage brewing systems 10, 110 and 210 described above. For convenience, similar components in the cups 312 and 314 utilize similar reference numerals to the cups described in other embodiments above.

In use, the second inner cup 314 is positioned within the first outer cup 312. The system 310 further comprises a filter 316, a beverage module 318 and a support structure 320 for facilitating the brewing process. The beverage module 318 contains a beverage material to be brewed, and is positioned within the system 310 such that manipulation of the inner cup 314 with respect to the outer cup 312, such as by telescoping the inner cup 314 out from the outer cup 312 to a brewing position (FIG. 14) or by twisting the inner cup 314 with respect to the outer cup 312, will open the beverage module 318 to expose beverage material contained therein for brewing.

As shown in FIG. 13, the filter 316 is positioned between an open bottom end 334 of the inner cup 312 and a closed bottom end 326 of the outer cup 314. In the embodiment shown, the filter 316 has a generally planar, circular shape and is held in position by the support structure 320. The circumference of the filter 316 generally corresponds to the circular opening defined by the open bottom end 334 of the inner cup 314. The filter 316 may be made of any suitable material and design that allows liquid to flow through the filter while keeping the material to be brewed, such as coffee grounds, tea leaves, or the like, separated and maintained behind the filter 316 so that loose beverage material does not contaminate the brewed beverage during drinking.

In alternative embodiments, the filter 316 could be attached to the bottom end 334 of the inner cup 314, or even be part of the inner cup 314, such as in the form of openings of perforations in a closed bottom end of the cup, the sidewall 336 of the inner cup 314, or a combination of both. In further embodiments, the filter 316 could be shaped and contoured to cover both the bottom end 334 as well as portions of the sidewall 336 of the inner cup 314 (as illustrated in FIGS. 3 and 4). In still further embodiments, the filter 316 could be a band that is positioned around just the sidewall 336 of the inner cup 314, with which design, the bottom end 334 of the inner cup 314 could be closed.

The material to be brewed is contained within an interior cavity 340 defined by the beverage module 318. In a preferred embodiment, the beverage module 318 is secured to the inner surface of the closed bottom end 326 of the outer cup 312. As shown, the beverage module 318 has a recess 342 formed in its bottom side 344 and is secured to the outer cup 312 by an adhesive material 346 positioned within the recess 342. The support structure 320 also braces the beverage module 318 in position against the bottom end 326 of the outer cup 312 when the inner cup 314 is positioned within the outer cup, such as when the brewing system 310 is being stored prior to use or when the inner cup 314 is in the drinking position.

Alternative means for securing or otherwise holding the beverage module 318 in position within the system 310 may be used. For example, the beverage module 318 may be formed as a pocket into the bottom end 326 of the outer cup 312. Alternatively, a bellows (as shown in FIGS. 16-19) may be used to hold the beverage module 318. Still alternatively, mechanical means for bracing the beverage module 318 may be used. Such mechanical means may be preferred if the beverage brewing system 310 is intended to be reusable—i.e., a used beverage module can be “unlocked” from its mechanical support and discarded and then replaced by a new beverage module that simply “locks” into place on the support.

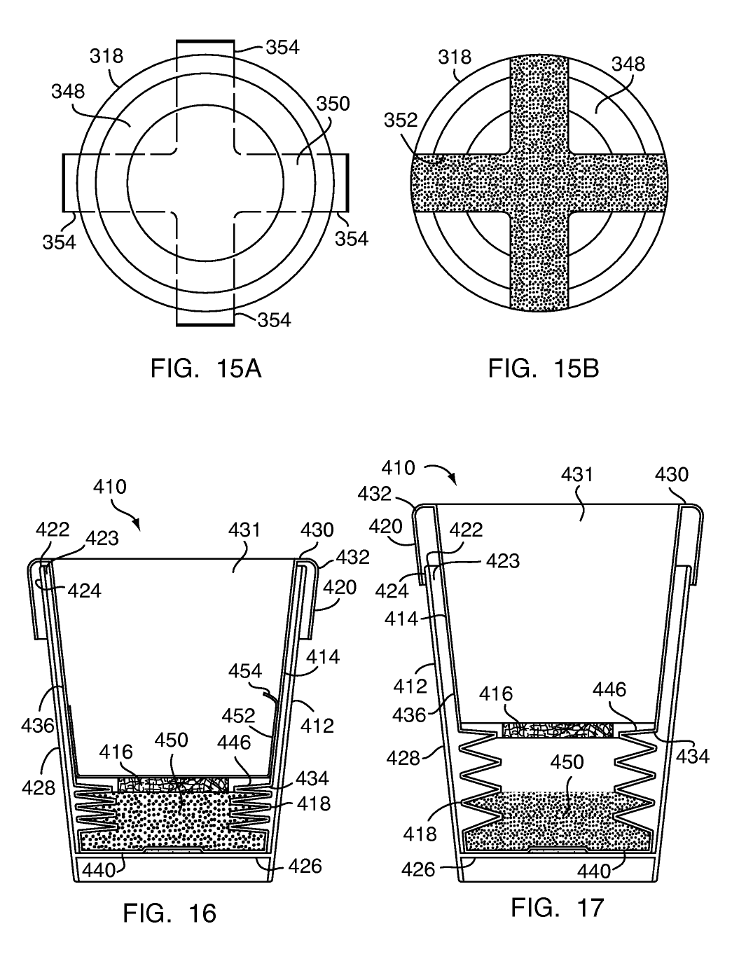

Brewing of a beverage using the system 310 is accomplished by exposing the beverage material contained within the beverage module 318. Referring to FIGS. 13 and 15A, a top surface 348 of the beverage module 318 is provided with a cover seal 350 that, when in sealed position, encloses beverage module 318 so that beverage material is stored therein and prevented from spilling from the system 310 when not in use (e.g., when the cups 312 and 314 are stacked and/or stored upside down). When the cover seal 350 is removed, the beverage module 318 is opened to expose the beverage material stored therein. An opening 352, illustrated in FIG. 15B in the form of a cross, is defined in the top surface 348 of the beverage module 318. The cover seal 350 is provided in the form of strips 354 attached on one end to the inner cup 314 or the support structure 320, and which, when in sealed position, cover the opening 352 in the beverage module 318. In order to brew a beverage in the system 310, the inner cup 314 is preferably telescoped from its storage position inside the outer cup 312. As the inner cup 314 is pulled upwardly out of the outer cup 312, the strips 354 are pulled with the inner cup 314 so that they detach from the beverage module 318 and uncover the opening 352, as is shown in FIG. 14. The cover seal 350 can be disengaged from the beverage module 318 by alternative means, such as by twisting the inner cup 314 relative to the outer cup 312.

The strips 354 may be attached to the beverage module 318 in the storage position using an adhesive that is forcibly disengaged so as to open the beverage module 318 and expose the beverage material for brewing. Alternatively, the strips 354 can be formed as part of the module's top surface 348 and separable via perforations defining the opening 352 that tear when a sufficient pulling force is applied to the cover seal 350. Still alternatively, the cover seal 350 can be manufactured from a material that will dissolve or degrade when exposed to water. In such an embodiment, the inner cup 314 would be telescoped so that water can be added to the brewing system 310, at which time the cover seal on the packet will dissolve and the beverage material can mix with the water to brew the beverage.

As noted, the support structure 320 preferably is attached to the bottom end 334 of the inner cup 314 and thus maintains the filter 316 in a constant relative position at the bottom end 334 of the inner cup 314. When the inner cup 314 is telescoped out from the outer cup 312, the support structure 320 and the filter 316 move with the inner cup 314. When the inner cup 314 is retracted within the outer cup 312 to the drinking position, the support structure 320 braces the beverage module 318.

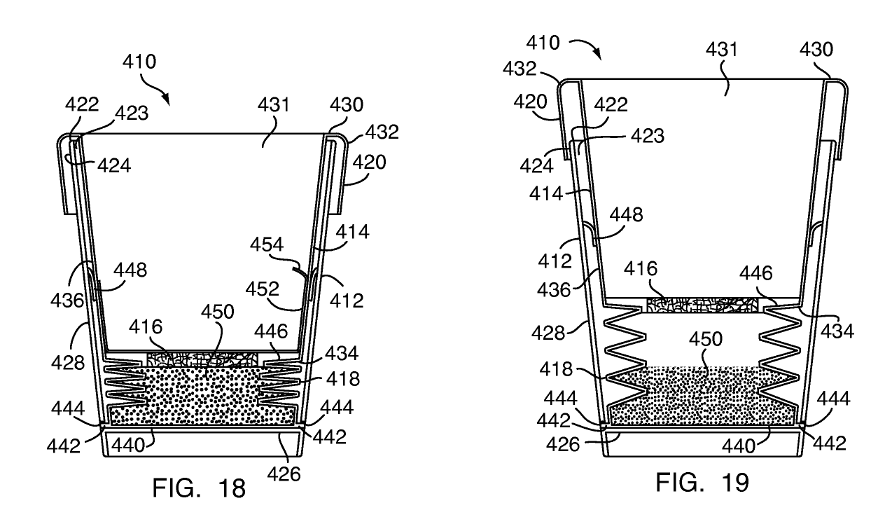

An additional annular seal (much in the form shown for the embodiment of FIGS. 18 and 19) can be used to support the beverage module 318 in its position at the bottom of the outer cup 312, especially when the inner cup 314 and the support structure 320 are pulled away from the beverage module 318. The seal preferably could be a flexible annular ring conforming to the interior cross-sectional space at the base of the outer cup 312 that radially extends between the support structure 320 and the inner sidewall of the outer cup 312 to prevent jostling of the inner cup 314 when the system 310 is being stored prior to use. That is, the inner cup 314 can be prevented from accidental removal from the outer cup 312, which in turn prevents premature release of the beverage material from the beverage module 318. Moreover, in order to pull the inner cup 314 from within the outer cup 312 to disengage the cover seal 350 from the beverage module 318 and begin the brewing process, the user can be required to apply some pulling force to counter the grasp of the additional annular seal. Additionally, when the system 310 is being used to drink a brewed beverage—i.e., after water has been added and the inner cup 314 has been returned to a position within the outer cup 312—the additional annular seal prevents loose beverage material from leaking through any space between the outer cup 312 and the inner cup 314.

Additional embodiments of a beverage brewing system in accordance with the present invention are illustrated in FIGS. 16-19. A beverage brewing system 410 generally comprises a first outer cup 412 and a second inner cup 414 positioned therein for telescoping movement, each cup preferably having similar configuration, with a filter layer 416 disposed therebetween for infusion brewing of a beverage. For convenience, similar components in the cups 412 and 414 utilize similar reference numerals to the cups described in other embodiments above.

The inner cup 414 is connected to the outer cup 412 via a bellows 418 that can be extended and retracted in conjunction with movement of the inner cup 414 with respect to the outer cup 412. The inner cup 414 further includes an extended lip 420 that essentially folds over and engulfs an upper rim region 424 of the outer cup 412 so as to prevent displacement and spillage of the brewed material when the inner cup 414 is returned to its drinking position within the outer cup 412. The extended lip 420 also provides a smooth surface for drinking of the brewed beverage.

As illustrated, the outer cup 412 comprises a top end 422 defining an opening 423 and the upper rim region 424, a closed bottom end 426, and a generally upstanding sidewall 428 extending circumferentially around the cup and connecting the upper rim region 424 and the bottom end 426. The inner cup 414 comprises a generally upstanding sidewall 436 extending circumferentially around the cup and connecting a top end 430 defining an opening 431 and an upper rim region 432 with a generally open bottom end 434 that generally complements the inner surface of the sidewall of the outer cup 412. The bellows 418 is connected to the respective bottom ends 426 and 434 of the outer and inner cups 412 and 414. As shown in the embodiment of FIGS. 16-17, a lower end 440 of the bellows 418 is attached to the closed bottom end 426 of the outer cup 412, preferably with an adhesive. As shown in the embodiment of FIGS. 18-19, the lower end 440 of the bellows 418 is snap-fit into the outer cup 412 using mechanical attachment means, preferably radially projecting tabs 442 that engage recesses 444 provided in the sidewall 428 of the outer cup 412.

The bellows 418 define an interior cavity in which beverage material to be brewed is stored. The interior cavity defines a maximum brewing volume when the inner cup 414 is telescoped out from the outer cup 412 and the bellows 418 are accordingly extended, as shown in FIGS. 17 and 19. The filter layer 416 is disposed in an upper end 446 of the bellows 418 proximate the bottom end 434 of the inner cup 414. As the inner cup 414 is raised out of the outer cup 412 to the brewing position, the filter layer 416 preferably maintains a constant position relative to the bottom end 434 of the inner cup 414. To brew the desired beverage, water is poured into the inner cup 414 and passes through the filter layer 416 into the interior cavity of the bellows 418. In this design, the water does not contact the outer cup 412. After sufficient time has elapsed for the beverage to be brewed, the inner cup 414 can be returned to the drinking position within the outer cup 412. The brewed beverage passes through the filter layer 416 into the interior volume of the inner cup 414. The filter layer 416 prevents loose beverage material, such as coffee grounds, tea leaves, or the like, from passing into the interior volume of the inner cup 414 when the beverage is being consumed.

Accordingly, the bellows 418 provide a sealed cavity between the cups where used beverage material can be maintained and prevented from leaking between the cups and/or into the drinkable beverage. Additionally, the bellows 418 prevents the inner cup 414 from being separated from the outer cup 412, which is useful where several beverage brewing systems 410 are stacked together for storage. Though illustrated as being mounted to the bottom end 434 of the inner cup 414, the bellows 418 may be integrally manufactured as part of the inner cup 414. Further, a flexible annular flange, generally illustrated as reference numeral 448, may be included to form a seal against the inner wall of the outer cup 412 as the inner cup 414 and the bellows 418 rise and lower during use of the beverage brewing system.

A beverage module 450 may be stored within the interior cavity of the bellows 418, as is shown, for example, in FIG. 16. Alternatively, the beverage material can be loosely stored in the bellows 418. Either way, a cover seal 452 is preferably provided to prevent premature exposure or spillage of loose beverage materials prior to use of the beverage brewing system 410. For example, the cover seal 452 can be provided as a top layer on the bellows 418 above the filter layer 416, and include a tab 454 accessible in the interior volume of the inner cup 414 and removable by the user's hand. Alternatively, if a beverage module 450 is used and positioned within the bellows 418 at the base thereof, the cover seal 452 can be attached to the interior wall of the bellows upper portion 446 so that when the inner cup 414 is telescoped out from the outer cup 412 and the bellows 418 is extended, the cover seal 452 will be removed from the beverage module 450 to expose the beverage material contained therein. Still alternatively, the beverage module 450 can be mounted to move with the inner cup 414 and the bellows 418, and have a lower seal that is disengaged from the beverage module 450 as it moves away from the bottom end 426 of the outer cup 412, and an upper seal that can be removed by the user's hand. Still alternatively, the cover seal 452 can be manufactured form a material that dissolves or degrades in hot water so that when water passes through the filter into the brewing volume within the bellows 418, the beverage material will be exposed once the cover seal dissolves or degrades.

As illustrated and described, the present invention provides a self-contained beverage brewing system that can make a single cup of the material to be brewed, such as coffee or tea, by an infusion brewing method. Preferably, the system is disposable, meaning that after the beverage is brewed and consumed, the system, including cups, filter layer, beverage module, used beverage material and other components can be discarded. In such a disposable embodiment, the cups may each be constructed from a suitable disposable material, such as cardboard, paperboard, plastic-coated paperboard, or polystyrene. Alternatively, the beverage brewing system can be manufactured for more than one use, such as by accommodating replaceable beverage modules. In such embodiments, the cups should be constructed from a durable material that will withstand multiple uses and fluctuations in temperatures of the liquid contained therein. Further the cups should be constructed from a material that will not be damaged or warped when, for example, the cups are separated to replace the beverage module.

The flexible seal 20 or 120 (e.g., FIGS. 3-4 and 6-7), flexible gasket 248 (e.g., FIG. 11), extended lip 18 or 420 (e.g., FIGS. 1 and 16), or flexible annular flange 448 (e.g., FIGS. 18-19) components described herein can be used with any of the various embodiments shown or described, and are not limited for use with the specific embodiments with which they are illustrated. Moreover, the aforementioned embodiments of the present invention can be designed to accommodate a cover or lid to prevent spills of brewed beverages, such as during travel.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A beverage brewing system for making a brewed beverage, comprising:
a first outer container having a top end defining an opening and an upper rim region, a closed bottom end, and a generally upstanding sidewall connecting the upper rim and the closed bottom end, said sidewall extending around the perimeter of said first outer container and defining an interior volume of said first outer container;
a second inner container having a top end defining an opening and an upper rim region, a bottom end defining an opening and a lower rim region, and a generally upstanding sidewall connecting the upper rim region and the lower rim region, said sidewall extending around the perimeter of said second inner container and defining an interior volume of said second inner container;
a filter positioned between the bottom end of the second inner container and the closed bottom end of the first outer container;
a beverage material disposed between the filter and the closed bottom end of the second outer container;
wherein the second inner container is movable with respect to the first outer container between a drinking position where the second inner container is positionable in the interior volume of the first outer container such that the respective upper rim regions of the first inner container and the second outer container are generally adjacent to one another, and a brewing position where the second inner container is telescoped out of the interior volume of the first outer container; and
wherein the filter is moveable with the second inner container so that when the second inner container is positioned in the brewing position a liquid can pass through the second inner container and the filter and into the interior volume of the first outer container for brewing of the beverage material housed therein.

2. The beverage brewing system according to claim 1, further comprising a flexible seal connecting the respective upper rims of the first outer container and the second inner container, wherein the flexible seal is extended when the second inner container is positioned in the brewing position and collapsed when the second inner container is positioned in the drinking position and provides a closure to the space between the inside of the sidewall of the first outer container and the outside of the sidewall of the second inner container.

3. The beverage brewing system according to claim 1, further comprising at least one side filter portion formed into the sidewall of the second inner container.

4. The beverage brewing system according to claim 1, further comprising a flexible sleeve disposed within the interior volume of the first outer container, said flexible sleeve defining an interior volume in which the beverage material is disposed and further including:
a lower end operatively connected to the first outer container; and
an upper end operatively connected to the second inner container;
said flexible sleeve being collapsible and extendable in conjunction with movement of the second inner container relative to the first outer container.

5. The beverage brewing system according to claim 4, wherein said flexible sleeve comprises bellows that are extended when the second inner container is telescopically moved relative to the first outer container and compressed when the second inner container is positioned in the interior volume of the first outer container, and
further wherein the filter is disposed at an upper end of the bellows and the beverage material is disposed within the bellows below said filter.

6. The beverage brewing system according to claim 1, further comprising a cover seal for storing the beverage material when the beverage brewing system is not in use, wherein removal of the cover seal exposes the beverage material to facilitate brewing of a beverage.

7. The beverage brewing system according to claim 6, wherein the cover seal is attached to the second inner container so that the cover seal is removed to open the beverage module by the telescoping movement of the second inner container relative to the first outer container.

8. The beverage brewing system according to claim 1, further comprising a beverage module housing the beverage material, said beverage module being positioned between the filter and the closed bottom end of the second outer container.

9. The beverage brewing system according to claim 8, further comprising a support structure mounted on the open bottom end of the second inner container, wherein the beverage module is supported by said support structure such that the support structure and the beverage module are moveable with the second inner container so that when the second inner container is positioned in the brewing position a liquid can pass through the second inner container, the filter, the support structure and the beverage module and into the interior volume of the first outer container for brewing of the beverage material housed in the beverage module.

10. The beverage brewing system according to claim 9, wherein the support structure comprises an upper end and a lower end connected to one another by a frangible flange, the beverage module being mounted within the upper end of the support structure and including a lower seal, the lower end of the support structure being provided with at least one projection directed towards the lower seal of the beverage module; and
further wherein the frangible flange of the support structure can be fractured by compressive force on the support structure from pressing down on the second inner container relative to first outer container so that the lower end of the support structure collapses within the upper end of the support structure and the at least one projection perforates the lower seal of the beverage module to expose the beverage material housed therein.

11. The beverage brewing system according to claim 10, wherein the at least one projection comprises an annular ring having a plurality of teeth.

12. The beverage brewing system according to claim 8, wherein the beverage module is attached to the closed bottom end of the first outer container; said beverage module further including a cover seal for maintaining the beverage material within the beverage module when the beverage brewing system is not in use, wherein removal of the cover seal exposes the beverage material to facilitate brewing of a beverage.

13. The beverage brewing system according to claim 1, wherein the bottom end of the second inner container is formed of a porous material that defines the filter which accordingly is moveable with the bottom end of the second inner container.

14. A beverage brewing system for making a brewed beverage, comprising:
a first outer container having a top end defining an opening and an upper rim region, a closed bottom end, and a generally upstanding sidewall connecting the upper rim region and the closed bottom end, said sidewall extending around the perimeter of said first outer container and defining an interior volume of said first outer container;
a second inner container having a top end defining an opening and an upper rim, a bottom end defining an opening and a lower rim region, and a generally upstanding sidewall connecting the upper rim region and the lower rim region, said sidewall extending around the perimeter of said second inner container and defining an interior volume of said second inner container;
a collapsible sleeve disposed within the interior volume of the first outer container and connecting the bottom end of the second inner container to the first outer container, said collapsible sleeve defining an interior volume;
a beverage material disposed within the interior volume of the sleeve;
a filter disposed at an upper end of the sleeve proximate the bottom end of the second inner container;
wherein the second inner container is movable with respect to the first outer container between a drinking position where the second inner container is positionable in the interior volume of the first outer container such that the respective upper rim regions of the first inner container and the second outer container are generally adjacent one another and the sleeve is compressed, and a brewing position where the second inner container is telescoped out of the interior volume of the first outer container and the sleeve is extended; and
further wherein the filter is moveable with the bottom end of the second inner container so that when the second inner container is positioned in the brewing position a liquid can pass through the second inner container and the filter and into the interior volume of the sleeve for brewing of the beverage material disposed therein.

15. The beverage brewing system according to claim 14, further comprising a mounting ring connected to the lower rim region of the second inner container, wherein the filter and the upper end of the collapsible sleeve are connected to the mounting ring.

16. The beverage brewing system according to claim 14, further comprising a cover seal disposed on top of the filter for keeping the beverage material in the collapsible sleeve when the beverage brewing system is not in use, wherein removal of the cover seal exposes the beverage material to facilitate brewing of a beverage.

17. The beverage brewing system according to claim 14, wherein the collapsible sleeve comprises a bellows that is collapsible and extendable with the movement of the second inner container relative to the first outer container, said bellows including a lower end attached to the first outer container, and an upper end attached to the bottom end of the second inner container.

18. A beverage brewing system for making a brewed beverage, comprising:
a first outer container having a top end defining an opening and an upper rim region, a closed bottom end, and a generally upstanding sidewall connecting the upper rim region and the closed bottom end, said sidewall extending around the perimeter of said first outer container and defining an interior volume of said first outer container;
a second inner container having a top end defining an opening and an upper rim, a bottom end defining an opening and a lower rim region, and a generally upstanding sidewall connecting the upper rim region and the lower rim region, said sidewall extending around the perimeter of said second inner container and defining an interior volume of said second inner container;
a support structure mounted on the bottom end of the second inner container;
a beverage module housing a beverage material, said beverage module being supported by the support structure and including a lower seal;
a filter positioned atop the beverage module;
a cover seal disposed atop said filter;
wherein the second inner container is movable with respect to the first outer container between a drinking position where the second inner container is positionable in the interior volume of the first outer container such that the respective upper rim regions of the first inner container and the second outer container are generally adjacent to one another, and a brewing position where the second inner container is telescoped out of the interior volume of the first outer container; and
wherein the support structure, the filter and the beverage module are moveable with the second inner container so that when the second inner container is positioned in the brewing position a liquid can pass through the second inner container, the support structure, the filter and the beverage module and into the interior volume of the first outer container for brewing of the beverage material housed in the beverage module after the cover seal and the lower seal have been breached to expose the beverage material.

19. The beverage brewing system according to claim 18, wherein the support structure comprises an upper end and a lower end connected to one another by a frangible flange, the beverage module being mounted within the upper end of the support structure and the lower end of the support structure being provided with at least one projection directed towards the lower seal of the beverage module; and
further wherein the frangible flange of the support structure can be fractured by compressive force on the support structure from pressing down on the second inner container relative to first outer container so that the lower end of the support structure collapses within the upper end of the support structure and the at least one projection perforates the lower seal of the beverage module to expose the beverage material housed therein.

20. The beverage brewing system according to claim 19, wherein the at least one projection comprises an annular ring having a plurality of teeth.
